(19) United States
(12) Patent Application Publication
(10) Pub. No.: US 2007/0192569 A1
(43) Pub. Date: Aug. 16, 2007

(54) Reverse polish notation processing device, and electronic integrated circuit including such a processing device

(75) Inventors: Sylvain Garnier, Nantes (FR); Bruno Faidherbe, Sainte-Luce-Sur-Loire (FR); Patrice Menard, Saint-Mars-Du-Desert (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Atmel Nantes SA, Nantes Cedex 3 (FR)

(21) Appl. No.: 11/657,386

(22) Filed: Jan. 24, 2007

(30) Foreign Application Priority Data
Jan. 24, 2006 (FR) 06/00648

(51) Int. Cl. G06F 9/30

(52) U.S. Cl. 712/202

(57) ABSTRACT

The disclosure relates to a reverse Polish notation processing device, allowing execution of a set of instructions wherein each instruction comprises N operands at most, where N≧1. The device implements management of a stack whose size is variable. Such a device includes: a storage device including a random access memory and a cache memory; a stack pointer managing device for managing a stack pointer; and a contents managing device for managing the contents of the stages of the stack, according to said stack pointer. For each of the first N stages of the stack, the content of said stage is stored in the cache memory, and for each of the other stages of the stack, the content of said stage is stored in the random access memory; allowing to manage content overflows from the cache memory towards the random access memory, and vice-versa.

### FIELD OF THE DISCLOSURE

The field of the disclosure is that of electronic circuits.

More precisely, the disclosure relates to a reverse Polish notation (or RPN) processing device of the type enabling the execution of instructions from a master unit.

A processing device such as this conventionally includes a stack of variable size, managed according to a “last in, first out” (or LIFO) mode with stack pointers. This stack makes it possible to store content on stages. A content, for example, is a byte. Each instruction from the master unit operates on the content of at least one stage. An instruction (also referred to as a command or transaction) consists of an operation code word (or “opcode”) and k operand word(s) (or “data words”), where k≧0. Therefore, a set of instructions comprises instructions of different sizes (i.e. comprising for example one, two, three or four words in total).

It is important to note that, in the present document, the term “stack” should be understood, in a broad sense, as any memory plane used to store a set of bits temporarily.

The processing device has numerous applications, such as for example the implementation of computation on numbers and/or algebraic expressions.

More generally, the device may be applied in any case in which the master unit sends the processing device instructions relating to arithmetic operations and/or data handling.

### BACKGROUND OF THE DISCLOSURE

The drawbacks of the prior art will now be described, via the above-mentioned specific application, wherein the processing device is implemented in software and executed by a microprocessor.

Reverse Polish notation, also referred to as postfix notation, is used to perform calculations without using brackets. Derived from the Polish notation presented in 1920 by the Polish mathematician Jan Lukasiewicz, it differs therefrom by the order of the terms: the operands are presented before the operators and not the other way around.

As a general rule, reverse Polish notation is used to handle calculations in stack form.

FIG. 1 illustrates an example of the progression of a LIFO stack for a specific case of calculation according to the reverse Polish notation principle. It should be noted that the structure of a LIFO stack is based on the principle that the last data item added to the structure will be the first to be removed. As seen below, the result of an instruction on the stack is either 0, 1, or −1.

In this specific case, the following operation is to be carried out: (2+1)*7+15.

As illustrated in FIG. 1, this operation is conveyed by the following sequence: (it is assumed that at the moment t0, the first stage of the stack, i.e. the lowest stage on the stack, reference Stage 0, is loaded with the value “0”)
at the moment t0, an instruction “push 15” is generated (where the value “15” is the last operand of the above-mentioned equation);
at the moment t0+1, the instruction “push 15” is executed (i.e. the value “15” is pushed in the stack), the value “15” is then stacked on Stage 0 (the result is 1) and the value “0” is moved from the first stage of the stack (Stage 0) to the second stage of the stack, referenced Stage 1. At the same moment t0+1, an instruction “push 7” is generated;
at the moment t0+2, the instruction “push 7” is executed, the value “7” is then stacked on Stage 0 (the result is 1) and the following movements are carried out (due to the fact that the value “7” has been pushed in the stack):
   the value “15” is moved from Stage 0 to Stage 1; and
   the value “0” is moved from Stage 1 to the third stage of the stack, referenced Stage 2.

At the same moment t0+2, an instruction “push 1” is generated;
at the moment t0+3, the instruction “push 1” is executed, the value “1” is then stacked on Stage 0 (the result is 1) and the following movements are carried out (due to the fact that the value “1” has been pushed in the stack):
   the value “7” is moved from Stage 0 to Stage 1;
   the value “15” is moved from Stage 1 to Stage 2, and
   the value “0” is moved from Stage 2 to the fourth stage of the stack, referenced Stage 3.

At the same moment t0+3, an instruction “push 2” is generated;
at the moment t0+4, the instruction “push 2” is executed, the value “2” is then stacked on Stage 0 (the result is 1) and the following movements are carried out (due to the fact that the value “2” has been pushed in the stack):
   the value “1” is moved from Stage 0 to Stage 1;
   the value “7” is moved from Stage 1 to Stage 2;
   the value “15” is moved from Stage 2 to Stage 3; and
   the value “0” is moved from Stage 3 to the fifth stage of the stack, referenced Stage 4.

At the same moment t0+4, an instruction “+” is generated, corresponding to an addition of the values located on Stages 1 and 0;
at the moment t0+5, the instruction “+” is executed, the value “1” on Stage 1 is then added to the value “2”, on Stage 0, and the result of this addition, i.e. the value “3”, is stored on Stage 0 (the result is −1). The following movements are then carried out (due to the fact that the values “1” and “2” have been absorbed):
   the value “7” is moved from Stage 2 to Stage 1;
   the value “15” is moved from Stage 3 to Stage 2; and
   the value “0” is moved from Stage 4 to Stage 3.

At the same moment t0+5, an instruction “*” is generated, corresponding to a multiplication of the values located on Stages 1 and 0;
at the moment t0+6, the instruction “*” is executed, the value “7” on Stage 1 is then multiplied by the value “3” on Stage 0, and the result of this multiplication, i.e. the value “21”, is stored on Stage 0 (the result is −1). The following movements are then carried out (due to the fact that the values “7” and “3” have been absorbed):
   the value “15” is moved from Stage 2 to Stage 1; and
   the value “0” is moved from Stage 3 to Stage 2.

At the same moment t0+6, an instruction “+” is generated, corresponding to an addition of the values located on Stages 1 and 0;
at the moment t0+7, the instruction “+” is executed, the value “15” on Stage 1 is then added to the value “21”, on Stage 0, and the result of this addition, i.e. the value “36”, is stored on Stage 0 (the result is −1). Due to the fact that the values “15” and “21” have been absorbed, the value “0” is moved from Stage 2 to Stage 1.

Very numerous software implementations of reverse Polish notation are already known.

As an example, the Hewlett Packard Company has developed a calculator equipped with a postfix programming language called reverse Polish lisp (or RPL), according to which a stack is software-implemented using a Saturn 4-bit microprocessor (marketed by Motorola) with RISC (“Reduced Instruction-Set Computer”) architecture.

One of the drawbacks of this type of implementation lies in the fact that it is very costly in terms of resources (memory, CPU, etc.).

In addition, this known implementation involves the drawback of requiring a software overlay.

Furthermore, the inventors of the present application observed that the use of an implementation such as this could lead to high electricity consumption.

### SUMMARY OF THE DISCLOSURE

An embodiment of the disclosure relates to a reverse Polish notation processing device, allowing to execute a set of instructions wherein each instruction comprises N operands at most, where N≧1, said device implementing management of a stack whose size is variable.

According to an embodiment of the invention, the device includes:
storage means including a random access memory and a cache memory;
means for managing a stack pointer, which is a physical address, in said random access memory, associated with a reference stage of the stack, each stage of the stack being associated with a physical address, in said random access memory, which varies according to the stack size;
means for managing the contents of the stages of the stack, according to said stack pointer:
such that, for each of the first N stages of the stack, the content of said stage is stored in said cache memory, and for each of the other stages of the stack, the content of said stage is stored in said random access memory, at the physical address associated with said stage;
allowing to manage content overflows from the cache memory towards the random access memory, and vice-versa.

Thus, an embodiment of the invention is based on a completely novel and inventive approach for managing a stack. As a matter of fact, an embodiment of the invention proposes to associate a random access memory with a cache memory. The combined use of the random access memory and the cache memory makes it possible to implement a LIFO stack, wherein the last data item added is stored in the cache memory. This configuration thus makes it possible to carry out rapid data processing (e.g. arithmetic operations), due to the fact that the contents of the first stages of the stack are stored in the cache memory. In addition, the random access and cache memory management mechanism is based on the use of a pointer continuously pointing to the physical address (in the random access memory) associated with this reference stage, so as to control the movements of the contents of the stages of the stack with respect to the reference stage.

According to one advantageous aspect of an embodiment of the invention, N is equal to 2.

In one preferred embodiment of the invention, the device is comprised in a coprocessor intended to cooperate with a main processor.

Advantageously, said reference stage of the stack is the first stage of the stack.

In another embodiment, the invention relates to an electronic integrated circuit including a processing device as cited above. An electronic integrated circuit is understood to mean, in particular, but not exclusively, a processor, a microprocessor, a controller, a microcontroller or a coprocessor.

### BRIEF DESCRIPTION OF THE DRAWINGS

Other characteristics and advantages will become apparent upon reading the following description of a one or more embodiments, given for non-limiting, illustrative purposes, and from the appended drawings in which:

FIG. 1, already described with respect to the prior art, is a representation of an example of the movement of the contents of the stages of a LIFO stack;

FIG. 2 illustrates a block diagram of a particular embodiment of the system, wherein an interfacing device is placed between the master unit and the processing device;

FIG. 3 is a logic diagram of a particular embodiment of the processing device;

FIG. 4 is a logic diagram of a particular embodiment of a ROM memory addressing mechanism implemented in a processing device;

FIG. 5 illustrates the implementation of a passage mechanism from an instruction register to a computing register;

FIG. 6 illustrates the implementation of a passage mechanism from a computing register to a random access memory;

FIG. 7 is an exemplary representation of the movement of the memory plane and of the computing registers of a processing device;

FIG. 8 illustrates a simplified logic diagram of a particular embodiment of an instruction decoder processing a multicycle instruction;

FIG. 9 illustrates a multicycle instruction status machine; and

FIG. 10 is a logic diagram of a particular embodiment of an implementation of a stack in a DPRAM.

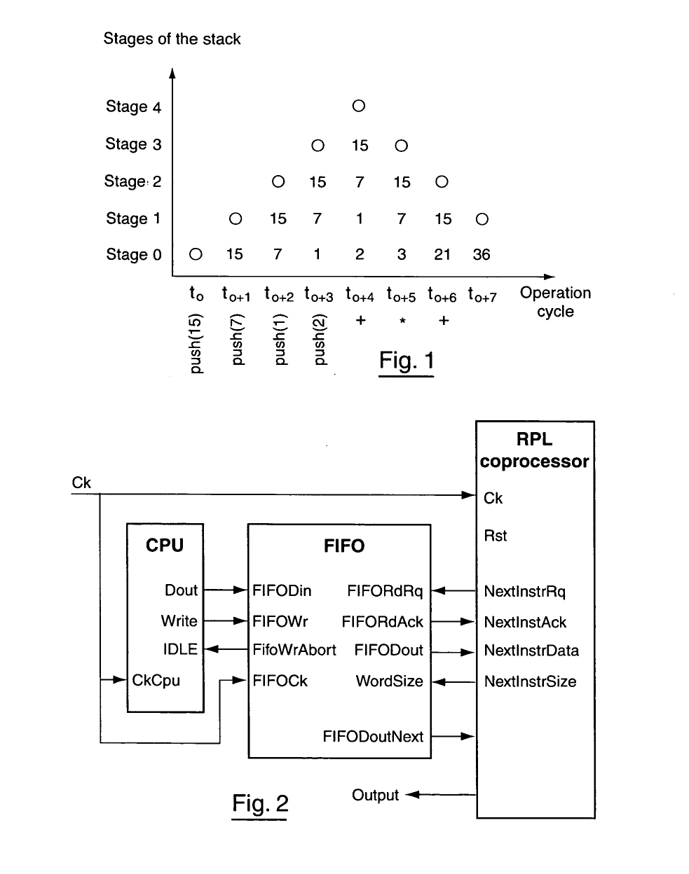

### DETAILED DESCRIPTION OF ILLUSTRATIVE EMBODIMENTS

### Description of One Particular Embodiment

In all of the figures of this document, identical elements or signals are designated by the same alphanumeric reference.

The disclosure thus relates to a hardware architecture for a reverse Polish notation processing device capable of optimal management of the pointers of a LIFO stack, whose first stages are implemented in a cache memory and the other stages in a random access memory. The basic principle of an embodiment of the invention is based on a technique for managing the content overflows of the stages from the cache memory towards the random access memory, and vice-versa.

Particular Configuration: Microprocessor/Coprocessor Interfacing

For non-limiting, illustrative purposes, the remainder of the description will deal with the following particular configuration illustrated in FIG. 2, wherein an interfacing device (generally called FIFO for “first in, first out”) is placed between a microprocessor (generally called a CPU, for “central processing unit”), acting as the master unit, and a coprocessor, in which the processing device of an embodiment of the invention is (hardware) implemented. It is clear that an embodiment of the invention can be implemented in an 8-bit, 16-bit, 32-bit, etc. type coprocessor.

It is recalled that, in a configuration such as this, the coprocessor processes information flows in order to reduce the load of the microprocessor. As a matter of fact, the microprocessor transmits instructions (i.e., variable-sized groups of words), via the interfacing device, to the coprocessor, in order for it to execute them. More precisely, the coprocessor comprises an instruction register fed by a request/acknowledgement mechanism enabling the execution of single-cycle or multicycle instructions and the handling of shortages when no instruction is supplied.

The interfacing device receives read requests from the coprocessor and write requests from the microprocessor. This interfacing device is used to store words from the microprocessor, via an input bus.

More precisely, in order to write words, the microprocessor sends write requests (FIFOWr=1) and places words (e.g. commands to be executed) on the input bus (FIFODin) of the interfacing device. When the interfacing device is full, it sends the microprocessor a memory full indication message (FifoWrAbort=1) so that it stops writing, so as to prevent any data corruption. The microprocessor is then placed instantaneously in idle mode. It only leaves this mode when the interfacing device has sufficient free space.

As illustrated in FIG. 2, in order to read words, the coprocessor sends read requests (FIFORdRq=1) and reads words on the output bus (FIFODout) of the interfacing device.

In a preferred embodiment, the interfacing device supplies the coprocessor with a signal FIFODoutNext, such that, while the interfacing device serves a current read request, the coprocessor can obtain a presumed value of the instruction associated with a subsequent read request early and supply the interfacing device with the size (WordSize) of the instruction associated with this subsequent read request. The coprocessor obtains the size (WordSize) of the next instruction by decoding the opcode word of the next instruction (present on FIFODoutNext), and by using the decoded opcode word to query a correspondence table (not shown) between the opcode words and the instruction sizes.

The interfacing device also comprises read request acknowledgement means, generating for each read request an acknowledgement signal with a value “true” (FIFORdAck=1) if a number of words at least equal to the size (WordSize) of the instruction associated with this read request is available on the output signal (FIFODout). When the interfacing device acknowledges the read request, the instruction register of the coprocessor samples the data present on its input NextInstrData.

It is noted that the microprocessor, the interfacing device and the coprocessor receive the same clock. In a preferred embodiment, this clock may be from an oscillator pad at the circuit input or an internal clock generation unit.

General Description of the Processing Device

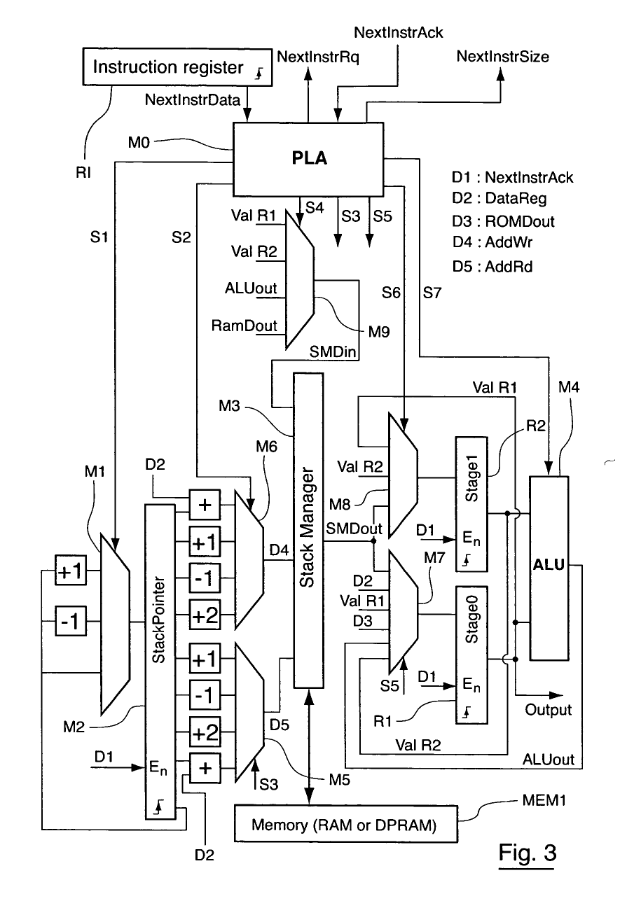

A processing device according to a preferred embodiment of the invention will now be described in relation to FIG. 3.

In this embodiment, the processing device is implemented in a coprocessor and comprises:
storage means including a random access memory RAM (MEM1) and a cache memory;
means M0, M1 and M2 for managing a stack pointer, which is a physical address, in the random access memory, associated with a reference stage of the stack. Each stage of the stack being associated with the physical address, in the random access memory, which varies according to the size of the stack. In the embodiment shown, the reference stage of the stack is the first stage Stage 0 of the stack;
means M0, M5, M6, M9, M3, M7 and M8 for managing the contents of the stages of the stack, with relation to the stack pointer such that, for each of the two first stages of the stack Stage 0 and Stage 1, the content of the stage is stored in the cache memory, and for each of the other stages of the stack, the content of the stage is stored in the random access memory, at the physical address associated with the stage. As will be seen subsequently, these means make it possible to manage content overflows from the cache memory towards the random access memory, and vice-versa.

More precisely, the processing device according to an embodiment of the invention comprises three families of elements:
a family of analogue elements comprising the random access memory RAM (MEM 1), wherein the stack is implemented. In another embodiment, the stack may be implemented in a DPRAM memory (MEM 2) (for “Dual Port RAM”);
a family of sequential elements comprising:
   an instruction register RI containing the current instruction to be executed;
   computing registers R1 and R2 (hereinafter referred to as the second and third register, respectively), containing the current values of the contents of the first Stage 0 and second Stage 1 stages of the stack, respectively.

It is important to note that in the present document, the term “register” should be understood, in a broad sense, as any circuit used to store a set of bits temporarily. The size of the abovementioned registers is defined firstly by the number of coprocessor instructions and secondly by the computing precision required by the arithmetic processing. In the remainder of the disclosure, it is assumed for example that the size of the instruction register RI is 5 bits and the size of the computing registers R1 and R2 is 32 bits;
a family of combinatory elements comprising:
   an instruction decoder M0, e.g. a PLA (for “Programmable Logic Array”), which processes the current instruction contained in the instruction register RI (i.e. it identifies the opcode word of the instruction), by means of microcode;
   an arithmetic computing unit M4 (or ALU (for “Arithmetic Logic Unit”)) used to execute an operation (depending on the current instruction), by means of arithmetic macros;
   a register M2 (hereinafter referred to as “StackPointer manager”) containing the current value of the stack pointer.
      Implementation of a Stack in a DPRAM

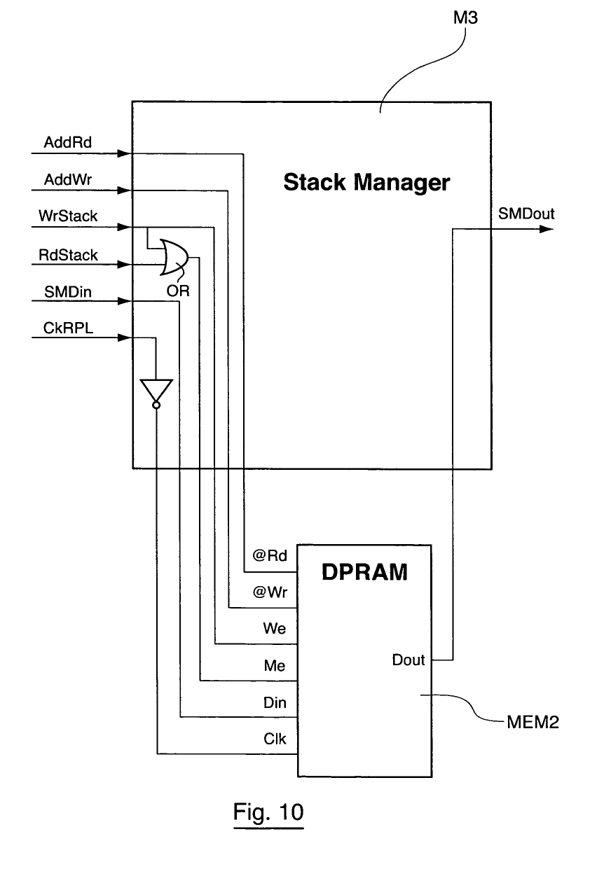

As mentioned above, the memory plane of the stack may be implemented in a DPRAM. FIG. 10 illustrates such an implementation.

In the embodiment illustrated, the inputs of the control means M3 (also referred to as the Stack Manager) to access the random access memory are connected to the inputs of the DPRAM (MEM 2), so as to enable a read (Me=1), write (We=1), no access (Me=0) or a read and write in the DPRAM.

It is important to note that, in order to carry out read and/or write access, the “memory enable” input (Me) of the DPRAM should be set to “1”. For this purpose, the inputs WrStack and RdStack of the Stack Manager are connected to the inputs of a logical OR gate, wherein the output is connected to the input Me of the DPRAM.

In this way, the input Me of the DPRAM is set to “1” when WrStack=1 and RdStack=0, WrStack=0 and RdStack=1 or WrStack=1 and RdStack=1, however, it is set to “0” when WrStack=0 and RdStack=0.

More precisely, in order to write words, the Stack Manager M3 sends a write indication message (WrStack=1) and specifies the address (AddWr) at which the words transmitted via the input bus (SMDin) of the Stack Manager are to be written.

In order to read words, the Stack Manager M3 sends a read indication message (RdStack=1) and specifies the address (AddRd) at which the words stored in the Stack Manager are to be read.

Detailed Description of Processing Device

The means for managing the stack pointer and the means for managing the contents of the stages of the stack specific to an embodiment of the invention will now be described in relation to FIG. 3.

In the illustrated embodiment, the means for managing the stack pointer include:
a first multiplexer M1 having three inputs receiving, respectively: the current value (StackPointer) of the stack pointer, the current value of the stack pointer incremented by one unit (StackPointer+1), and the current value of the stack pointer decremented by one unit (StackPointer−1). This first multiplexer M1 delivers at its output one of the three input values of a current instruction, on the basis of a first control signal S1 taking into account the result on the stack, +1, −1 or 0. In other words, the first multiplexer M1 provides the next physical address in memory of the first stage Stage 0 of the stack;
a first register M2 containing the current value of the stack pointer (i.e., the current physical address in memory of the first stage of the stack), and whose input is connected to the output of the first multiplexer M1. This first register M2 is activated by an activation signal (En) indicating that a next instruction is ready (NextInstrAck=1).

In order to manage the contents of the stages of the stack, the processing device includes:
means for determining the next write address AddWr in the random access memory RAM. These determination means include a second multiplexer M6 that has four inputs: the first input receiving the current value (StackPointer) of the stack pointer incremented by the number of units DataReg indicated in the operand word of the current instruction, the second input receiving the current value of the stack pointer incremented by one unit (StackPointer+1), the third input receiving the current value of the stack pointer incremented by two units (StackPointer+2) and the fourth input receiving the current value of the stack pointer decremented by one unit (StackPointer−1). The second multiplexer M6 delivers at its output one of the input values, on the basis of a second control signal S2, which is based on the current instruction;
means for determining the next read address AddrRd in the random access memory RAM. These determination means include a third multiplexer M5 that has four inputs: the first input receiving the current value of the stack pointer incremented by the number of units DataReg, the second input receiving the current value of the stack pointer incremented by one unit, the third input receiving the current value of the stack pointer incremented by two units and the fourth input receiving the current value of the stack pointer decremented by one unit. The third multiplexer M5 delivers at its output one of the input values, on the basis of a third control signal S3, which is based on the current instruction;

As will be seen below, certain instructions make it possible to read or write data anywhere in the stack. The means for determining the next write AddWr or read AddrRd address according to an embodiment of the invention advantageously make it possible to calculate the physical address to be reached with respect to the current value of the stack pointer;
means for determining the next data to be written in the random access memory RAM. These means include a fourth multiplexer M9 that has four inputs receiving, respectively: the current content (ValR1) of the first stage Stage 0 of the stack (i.e., the content of the register R1), the current content (ValR2) of the second stage Stage 1 of the stack (i.e., the content of the register R2), data SMDout read in the random access memory RAM during execution of the current instruction, and data ALUout calculated during execution of the current instruction. The fourth multiplexer M9 delivers at its output one of the input values, on the basis of a fourth control signal S4, which is based on the current instruction;
means for determining the next value to be written in the cache memory for the content of the first stage. These determination means include a fifth multiplexer M7 that has six inputs: the first input receiving the current value (ValR1) of the content of the first stage Stage 0, the second input receiving the current value (ValR2) of the content of the second stage Stage 1, the third input receiving the value DataReg, the fourth input receiving the data SMDout, the fifth input receiving the data ALUout and the sixth input receiving data (RomDout) read in a read only memory ROM (MEM 3). The fifth multiplexer M7 delivers at its output one of the input values, on the basis of a fifth control signal S5, which is based on the current instruction, for example:
   if the current instruction is an instruction of the type not modifying R1, then the multiplexer M7 delivers the value on the first input;
   if the current instruction is a “DROP” type instruction, then the multiplexer M7 delivers the value on the second input;
   if the current instruction is a “PUSH” type instruction, then the multiplexer M7 delivers the value on the third input;
   if the current instruction is a “DUP” type instruction, then the multiplexer M7 delivers the value on the fourth input;
   if the current instruction is a “ADD” type instruction, then the multiplexer M7 delivers the value on the fifth input;

It is important to note that the cache memory includes a register R1, containing the current value of the content of the first stage Stage 0. The input of the second register is connected to the output of the fifth multiplexer M7. This second register is activated by an activation signal (En) indicating that the next instruction is ready (NextInstrAck=1);
means for determining the next value to be written in the cache memory for the content of the second stage Stage 1. These determination means include a sixth multiplexer M8 that has three inputs receiving, respectively: the current value of the content of the first stage Stage 0, the current value of the content of the second stage Stage 1, and the data SMDout. The sixth multiplexer M8 delivers at its output one of the input values, on the basis of a sixth control signal S6, which is based on the current instruction, for example:
   if the current instruction is a positive result instruction on the stack, then the multiplexer M8 delivers the content of the first stage Stage 0;
   if the current instruction is an instruction of the type not modifying R2, then the multiplexer M8 delivers the content of the second stage Stage 1;
   if the current instruction is a “DUP” type instruction, then the multiplexer M8 delivers the data SMDout.

It is noted that the cache memory includes a third register R2 containing the current value of the content of the second stage Stage 1. The input of the third register is connected to the output of the sixth multiplexer M8. This third register is activated by an activation signal (En) indicating that a next instruction is ready (NextInstrAck=1).

In order to execute an operation, which is based on the current instruction, the processing device further includes a arithmetic calculation unit M4 having two inputs receiving, respectively: the current value of the content of the first stage Stage 0 and the current value of the content of the second stage Stage 1. This arithmetic calculation unit M4 delivers at its output the data ALUout calculated with an arithmetic operator, e.g., an adder, subtractor, multiplier, etc., selected by a seventh control signal S7.

As illustrated in FIG. 3, each control signal S1 to S7 is delivered by an instruction decoder M0, which processes the current instruction contained in the instruction register RI.

In the present embodiment, the processing device also comprises a read only memory ROM.

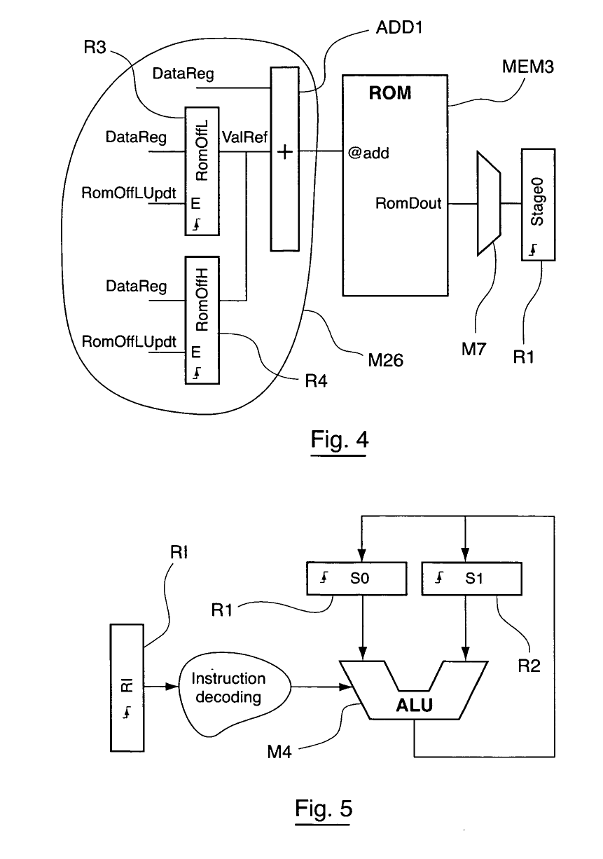

The addressing mechanism of such a ROM memory (MEM 3) is described below with reference FIG. 4.

This addressing mechanism comprises means M26 for determining the next read address in the read only memory ROM. The means M26 comprise an adder (ADD1), used to add the value DataReg, indicated in the operand word of the current instruction, to a reference value (ValRef). The adder output is connected to the read only memory and forms the next read address (@add) in the read only memory. As mentioned above, the output (RonDout) of the read only memory ROM, on which the data item read is located, is connected to the sixth input of the fifth multiplexer M7.

The means M26 for determining the next read address in the read only memory ROM also comprise a fourth register RomOffL (R3) containing least significant bits of the reference value and a fifth register RomOffH (R4) containing most significant bits of the reference value.

Data Path from Instruction Register RI to Computing Registers R1 and R2

The data paths from the instruction register RI to the computing registers R1 and R2 will now be described with reference to FIG. 5.

The critical data paths are between the synchronous elements timed by the same clock. The data paths passing through the arithmetic calculation unit M4 must be controlled as they are critical from a synchronisation point of view. Therefore, it is not advisable to have direct access to the random access memory RAM where the access and clock trees are characterised with considerable difficulty.

In this way, the two bottom stages of the stack Stage 0 and Stage 1 are each implemented with hardware in a register R1 and R2 to enable the control of the combinatory logic passage time, due to the handling of these constraints by clock tree synthesis and creation tools.

The term synthesis tool refers to a tool used to carry out transcription of a description of a hardware device written in RTL (for “Register Transfer Level”) high-level language in a functional equivalent written in the form of a netlist gate (i.e. a set of interconnected gates).

As a general rule, any logical gate or any interconnection introduces delays in electrical signal propagation. A clock tree is obtained when any synchronous element on a clock receives the latter without delay with respect to any other synchronous element receiving said clock, i.e. the phase shift between two toggle clock inputs from the same domain taken in pairs is zero.

Data Path Between Computing Register R2 and Random Access Memory RAM

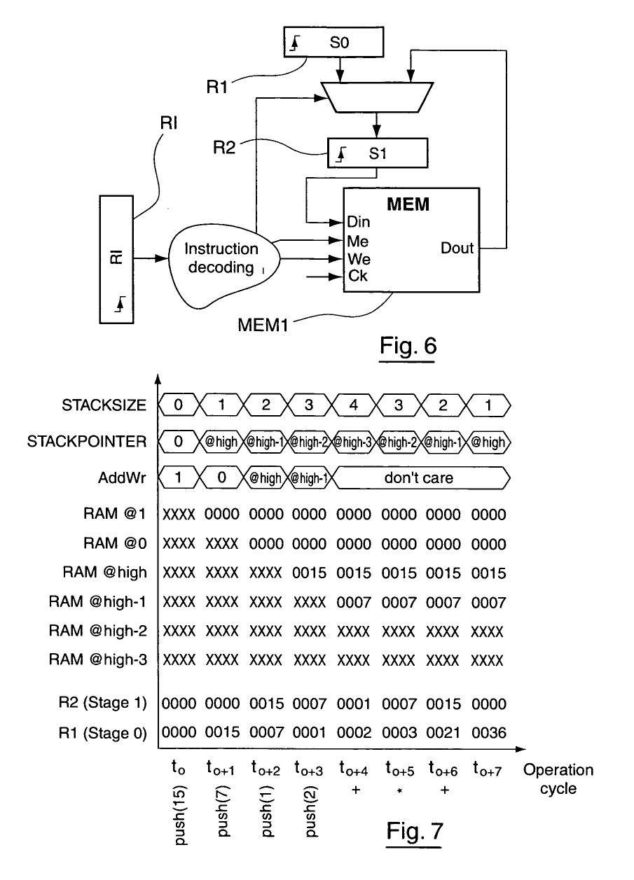

As illustrated in FIG. 6, access to the random access memory RAM (MEM 1) is carried out either when a data item overflows from the register R2, i.e. when the content of the second stage of the stack is moved to the third stage of the stack, in this first case, the stack result is positive; or when a data item is absorbed in the register R1 and it is necessary to update the register R2, i.e. move the content of the third stage of the stack to the second stage of the stack, in the second case, the stack result is negative.

For the sake of clarity, in the remainder of the description, the first and second stages of the stack are referenced S0 and S1, respectively.

Description of a Negative Result Instruction on the Stack

An instruction used to update the register R2 with the content of the third stage of the stack in RAM memory is described below.

More precisely, the microcode of the instruction ADD32 is described. This instruction ADD32 is used firstly to add the contents of the first S0 and second S1 stages of the stack and second to update the first stage of the stack S0 with the result of the addition and the second stage of the stack S1 with the content of the third stage.

This instruction ADD32 is conveyed by the following sequence:
S0<=S0+S1: S0 takes the value of the result of the operation;
S1<=Mem(StackPointer): S1 is updated with the content of the top stage of the stack (i.e. the third stage located in the RAM memory plane);
StackPointer<=StackPointer+1: by convention, StackPointer is incremented when the result of an operation on the stack is −1. StackPointer is the physical address in the RAM memory of the first stage of the stack. When an element (i.e. the content of a stage) is absorbed, by convention, the pointer is moved up one unit.

Note that the result of the stack is negative due to the fact that the instruction ADD32 induces the absorption of two operand data items for the return of a resulting data item.

Description of a Positive Result Instruction on the Stack

An instruction used to write the content of the register R2 on the third stack of the stack in RAM memory is described below.

More precisely, the microcode of the instruction PUSH(data) is described. This instruction PUSH(data) is used to move the contents of the first S0 and second S1 stages of the stack to the second and third stages, respectively.

This instruction PUSH(data) is conveyed by the following sequence:
Mem(StackPointer)<=S1: the content of the second stage of the stack S1 overflows into the RAM memory plane, i.e. the content of the stage S1 is written in the third stage;
S1<=S0: the content of the first stage of the stack S0 is shifted to the second stage S1;
S0<=data: the value data is entered in the first stage of the stack S0.

It should be noted that the result of the stack is positive due to the fact the instruction PUSH(data) induces the stacking of an additional data item.

Discussion of the Chronograms in FIG. 7

FIG. 7 is an exemplary representation of the movement of the RAM memory plane and the registers R1 and R2 of a processing device according to an embodiment of the invention.

On the x-axis, the operation cycle (i.e. a series of instructions) has been represented and, on the y-axis, the following information has been represented:
STACKSIZE, indicating the current size of the stack (i.e. the number of elements in the stack at the current time);
STACKPOINTER, indicating the current value of the stack pointer, i.e. the current physical address in the RAM memory plane of the first stage of the stack R1;
AddWr, indicating the next write address of the content of the second stage of the stack R2 in the RAM memory plane. It is important to note that AddWr=STACKPOINTER+1;
RAM @1 to RAM @high-3, representing the physical addresses of the RAM memory plane;
R1 and R2, representing the first and second stages of the stack, respectively.

In this example, the following operation is to be carried out: (2+1)*7+15.

As illustrated in FIG. 7, this operation is conveyed by the following sequence: (it is assumed that at the moment to, the first and second stages of the stack are loaded with the value “0”, and that STACKPOINTER equals 0)
at the moment t0, an instruction “push 15” is generated (where the value “15” is the last operand of the abovementioned equations). It is important to note that, at this moment, the physical address of the first and second stages of the stack R1 and R2 is RAM @0 and RAM @1, respectively. As a matter of fact, at this movement, STACKPOINTER points to the address RAM @0. Moreover, it is noted that the next write address of the content of R2 is RAM @1;
at the moment t0+1, the instruction “push 15” is executed, the value “15” is then stacked on R1 (the stack result is 1, STACKSIZE=1, there is one element in the stack), the content of R1 “0” is moved to R2, and the content of R2 “0” is moved in the memory plane to the address RAM @1. The physical address of the first and second stages of the stack R1 and R2 is RAM @high and RAM @0, respectively. As a matter of fact, at this moment, STACKPOINTER points to the address RAM @high. Moreover, it is noted that the next write address of the content of R2 is RAM @0. At the same moment, an instruction “push 7” is generated;
at the moment t0+2, the instruction “push 7” is executed, the value “7” is then stacked on R1 (the stack result is 1, STACKSIZE=2, there are two elements in the stack), the content of R1 “15” is moved to R2, and the content of R2 “0” is moved in the memory plane to the address RAM @0. The physical address of the first and second stages of the stack R1 and R2 is RAM @high-1 and RAM @high, respectively. As a matter of fact, at this moment, STACKPOINTER points to the address RAM @high-1. Moreover, it is noted that the next write address of the content of R2 is RAM @high. It is noted that the content stored at the address RAM @1 is unchanged. At the same moment, an instruction “push 1” is generated;
at the moment t0+3, the instruction “push 1” is executed, the value “1” is then stacked on R1 (the stack result is 1, STACKSIZE=3, there are three elements in the stack), the content of R1 “7” is moved to R2, and the content of R2 “15” is moved in the memory plane to the address RAM @high. The physical address of the first and second stages of the stack R1 and R2 is RAM @high-2 and RAM @high-1, respectively. As a matter of fact, at this moment, STACKPOINTER points to the address RAM @high-2. Moreover, it is noted that the next write address of the content of R2 is RAM @high-1. It is noted that the contents stored at the addresses RAM @1 and RAM @0 are unchanged. At the same moment, an instruction “push 2” is generated;
at the moment t0+4, the instruction “push 2” is executed, the value “2” is then stacked on R1 (the stack result is 1, STACKSIZE=4, there are four elements in the stack), the content of R1 “1” is moved to R2, and the content of R2 “7” is moved in the memory plane to the address RAM @high-1. The physical address of the first and second stages of the stack R1 and R2 is RAM @high-3 and RAM @high-2, respectively. As a matter of fact, at this moment, STACKPOINTER points to the address RAM @high-3. It is noted that the contents stored at the addresses RAM @1, @0 and @high are unchanged. At the same moment, an instruction “+” (i.e. the instruction ADD32) is generated. As seen below, this instruction has a negative result on the stack, therefore there will be no write in the RAM memory plane (AddWr=don't care).
at the moment t0+5, the instruction “+” is executed, the content of R2 “1” is then added to the content of R1 “2”, and the result of this addition “3” is stored on R1. At this moment, STACKPOINTER points to the address RAM ®high-2, the physical address of the first and second stages of the stack R1 and R2 is then RAM @high-2 and RAM @high-1, respectively. R2 being empty (its content having been absorbed), it is loaded with the content “7” stored at the address RAM @high-1 (the stack result is −1, STACKSIZE=3). At the same moment, an instruction “*” (i.e. the instruction MUL32) is generated.
at the moment t0+6, the instruction “*” is executed, the content of R2 “7” is then multiplied by the content of R1 “3”, and the result of this multiplication “21” is stored on R1. At this moment, STACKPOINTER points to the address RAM @high-1, the physical address of the first and second stages of the stack R1 and R2 is then RAM @high-1 and RAM @high, respectively. R2 being empty (its content having been absorbed), it is loaded with the content “15” stored at the address RAM @high (the stack result is −1, STACKSIZE=2). At the same moment, an instruction “+” (i.e. the instruction ADD32) is generated.
at the moment t0+7, the instruction “+” is executed, the content of R2 “15” is then added to the content of R1 “21”, and the result of this addition “36” is stored on R1. At this moment, STACKPOINTER points to the address RAM @high, the physical address of the first and second stages of the stack R1 and R2 is then RAM @high and RAM @0, respectively. R2 being empty (its content having been absorbed), it is loaded with the content “0” stored at the address RAM @0 (the stack result is −1, STACKSIZE=1).
   Set of Instructions

Presented in appendix 1 and 2 are examples of instructions that can be executed by the processing device according to an embodiment of the invention. These appendices form an integral part of this description.

A distinction may be made between two families of instructions: an arithmetic family (appendix 1), used for example to add the contents of the first and second stages of a stack, and a data handling family (appendix 2), used for example to invert the content of the first stage of a stack with that of the x^{th} stage.

Multicycle Instruction

As mentioned above (FIG. 3), each command signal S1 to S7 is delivered by the instruction decoder M0 (for example a PLA). This instruction decoder M0 also delivers a command signal NextInstrRq which is based on the decoding of the current instruction.

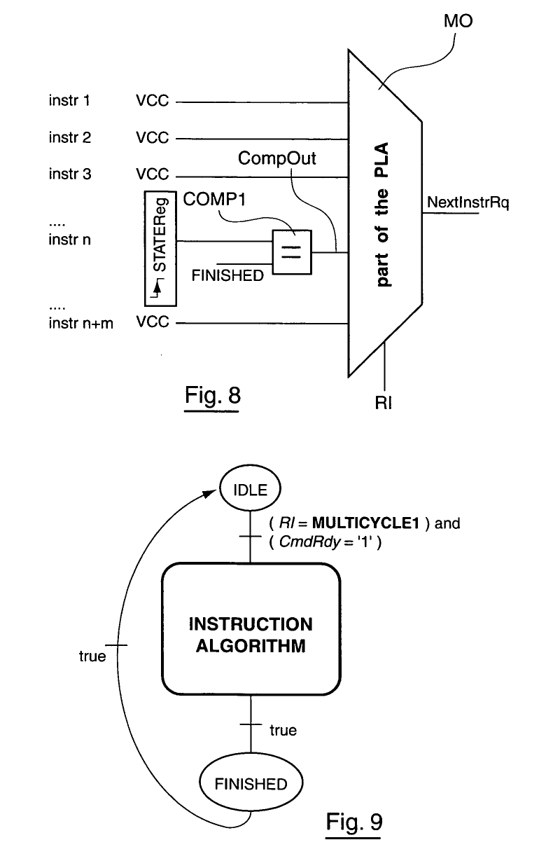

In the embodiment illustrated in FIG. 8, the PLA comprises a multiplexer which has several inputs each receiving a high power supply voltage VCC, indicating the presence of a single-cycle instruction (instr 1, instr 2, instr 3 and instr n+m), and an input receiving the output signal (CompOut) of a comparator (COMP1), this output signal (CompOut) is equal to the high power supply VCC when the multiplexer instruction (instr n) is complete. This multiplexer outputs one of the inputs, based on a control signal RI. In this way, for a single-cycle instruction, the control signal NextInstrRq automatically takes the value “1” (NextInstrRq=1), however, for a multicycle instruction, the control signal NextInstrRq takes the value “1” (NextInstrRq=1) when the instruction is complete.

As illustrated in FIG. 9, an instruction may be implemented in the form of a status machine. When the instruction MULTICYCLE1 is decoded (i.e. when the opcode of the instruction is identified by the PLA) and correctly formed (CmdRdy=1), the status machine quits the initial status IDLE. At the end of the function algorithm, the changeover to the final status FINISHED determines the changeover to “1” of the control signal NextInstrRq. In the embodiment illustrated in FIG. 3, the activation signal (NextInstrAck=1) of the instruction register RI and the computing registers R1 and R2 changes to “1” when an instruction is available in the control FIFO (not shown), after a request NextInstrRq is sent from the PLA to the FIFO.

Appendix 1: Arithmetic Instructions

The table below summarises the various arithmetic family instructions. The first column of the table identifies the name of the instruction, the second column specifies the argument (operand), the third one describes the arithmetic operation to be carried out and the last one indicates the result on the stack.

ARITHMETIC

| | | | |
|---|---|---|---|
| ADD32 | none | S0 <= S0 + S1 | −1 |
| SUB32 | none | S0 <= S0 − S1 | −1 |
| SHIFTL | none | S0 <<= 1 (unsigned) | 0 |
| SHIFTRS | none | S0 >>= 1 (unsigned) | 0 |
| NORMFLOAT | none | WMA normalization of float | |
| | | Operands | |
| | | iFraction: Stage1Reg | 0 |
| | | iFracBits: Stage0Reg | |
| | | returns on stage 1/stage0 the result | |
| RMAX | none | Stage0 <= {Stage0 < Stage1} ? Stage1: | −1 |
| | | Stage0 | |
| RMIN | none | Stage0 <= {Stage0 < Stage1} ? Stage0: | −1 |
| | | Stage 1 | |
| NEG | none | S <= ≈S0 − 1 | 0 |
| SHL8ADD(x) | 8 bits | S0 <= (S0 << 8) ¦ x | 0 |
| FMULSH16 | none | if RPLCON.0 = 0 then | |
| | | Stage0, = (uint32) | |
| | | (((int32)((B_operand >> 11) + 1) >> 1)) * | |
| | | ((int32)(A_operand >> 16))) | −1 |
| | | else FMULSH25 (WMA) | |
| | | Stage0 <= (int32)((((long long | |
| | | int)(((A_operand >> 15) + 1) >> 1))*((long | |
| | | long | |
| | | int)(((B_operand >> 6) + 1) >> 1))) >> 9) | |

For the sake of clarity in the remainder of the description, for each of the instructions listed in the above table, the role of each instruction is clearly identified and its hardware implementation is specified, i.e., the state or action carried out by each means M0 to M9 of the processing device according to an embodiment of the invention is indicated.

1. Instruction ADD32

This instruction is used to absorb the contents of the first and second stages of the first and second stages and add them, the result becoming the new content of the first stage, with a result of −1 on the stack.

This instruction ADD32 is conveyed by the following sequence:

M0: decodes the instruction;

M4: selects the ALU addition operator, the ALU output multiplexer is set to the adder output;

M7: selects the ALU output;

M1: selects the input corresponding to StackPointer+1 (result of −1 on the stack);

M2: is updated at the next clock stroke, if the enable input of the register is set to “1” (NextInstrAck=1);

M5: selects the input corresponding to StackPointer+1 (the data returned to R2 will be read),

M6: quiescent state (no write planned on this instruction irrespective of the selection);

M9: quiescent state (no write planned on this instruction irrespective of the selection);

M0: sets the inputs memory enable “Me” and write enable “We” of M3 to “1” and “0”, respectively, therefore, a read will be performed at the address selected by M5;

M8: selects the StackManager output

2. Instruction SUB32

This instruction is used to absorb the contents of the first and second stages, subtract the content of the second stage from the content of the first stage, the result becoming the new content of the first stage, with result of −1 on the stack.

This instruction SUB32 is conveyed by the following sequence:

M0: decodes the instruction;

M4: selects the ALU subtraction operator, the ALU output multiplexer is set to the subtractor output;

M7: selects the ALU output;

M1: selects the input corresponding to StackPointer+1 (result of −1 on the stack);

M2: is updated at the next clock stroke, if the enable input of the register is set to “1” (NextInstrAck=1);

M5: selects the input corresponding to StackPointer+2 (the data returned to R2 will be read)

M6: quiescent state;

M9: quiescent state;

M0: sets the inputs memory enable “Me” and write enable “We” of M3 to “1” and “0”, respectively, therefore, a read will be performed at the address selected by M5;

M8: selects the StackManager output.

3. Instruction SHIFTL

This instruction is used to perform an unsigned shift to the left of one bit of the content of the first stage, the result becoming the new content of the first stage, with a result of 0 on the stack.

This instruction SHIFTL is conveyed by the following sequence:

M0: decodes the instruction;

M4: selects the bit left shift operator;

M7: selects the ALU output;

M1: selects the input corresponding to StackPointer (result of 0 on the stack);

M2: is updated at the next clock stroke, if the enable input of the register is set to “1” (NextInstrAck=1);

M5: quiescent state;

M6: quiescent state;

M9: quiescent state;

M0: sets the inputs memory enable “Me” and write enable “We” of M3 to “0”, there is no read or write;

M8: selects the input R2.

4. Instruction SHIFTRS

This instruction is used to perform a signed shift to the right of one bit of the content of the first stage, the result becoming the new content of the first stage, with a result of 0 on the stack.

This instruction SHIFTRS is conveyed by the following sequence:

M0: decodes the instruction;

M4: selects the signed bit right shift operator (the signed bit right shift operator assigns the old most significant bit to the new one, so as to retain the sign);

M7: selects the ALU output;

M1: selects the input corresponding to StackPointer (result of 0 on the stack);

M2: is updated at the next clock stroke, if the enable input of the register is set to “1” (NextInstrAck=1);

M5: quiescent state;

M6: quiescent state;

M9: quiescent state;

M0: sets the inputs memory enable “Me” and write enable “We” of M3 to “0”, there is no read or write;

M8: selects the input R2.

5. Instruction NORMFFLOAT

This instruction is used to normalise two numbers present on the first two stages of the stack if we consider that stage 1 contains iFraction which represents a mantissa and stage 0 contains iFracBits which contains an exponent used to represent a floating point value using two fixed point numbers according to the following formula: value=iFraction*2ˆ(−iFracBits). Therefore, this avoids the use of an FPU (for “Floating Point Unit”) coprocessor which requires significant hardware or software resources.

In this way, multiplying two numbers consists of multiplying the mantissas and adding the exponents. However, it is necessary to normalise the operation after such an operation. The mantissa may be a multiple of two which makes it necessary to increment the exponent and divide the mantissa by the number of times that the mantissa is divisible by 2.

This instruction NORMFFLOAT is conveyed by the following sequence:

Multicycle instruction: At each clock cycle:

M0: decodes the instruction;

M2: StackPointer remains unchanged (result of zero on the stack);

ACTION 0:

M7: selects R1 (R1 remains unchanged);

ACTION 1:

M8: selects the output of an operator shifting R1 2 bits to the left;

M4: selects the operator (R2)+2;

M7: selects the ALU output;

ACTION 2:

M8: selects the output of an operator shifting R1 1 bit to the left;

M4: selects the operator (R2)+1;

M7: selects the ALU output;

ACTION 3:

M8: selects the output of an operator shifting R1 2 bits to the left;

M4: selects the operator R2+2;

M7: Selects the ALU output;

ACTION 4:

M8: selects the output of an operator shifting R1 1 bit to the left;

M4: selects the operator R2+1;

M7: selects the ALU output.

6. Instruction RMAX

This instruction is used to absorb the contents of the first and second stages and select the content with the highest value, the result becoming the new content of the first stage, with a result of −1 on the stack.

This instruction RMAX is conveyed by the following sequence:

M0: decodes the instruction;

M4: selects the operator MAX, compares R1 to R2, returns the highest value to the ALU output, S<=(R1<R2)?R2: R1;

M7: selects the ALU output;

M1: selects the input corresponding to StackPointer+1 (result of −1 on the stack);

M2: is updated at the next clock stroke, if the enable input of the register is set to “1” (NextInstrAck=1);

M5: selects the input corresponding to StackPointer+2 (the data returned to R2 will be read);

M6: quiescent state;

M9: quiescent state;

M0: sets the inputs memory enable “Me” and write enable “We” of M3 to “1” and “0”, respectively, therefore, a read will be performed of the future value of R2;

M8: selects the StackManager output.

7. Instruction RMIN

This instruction is used to absorb the contents of the first and second stage and select the content with the lowest value, the result becoming the new content of the first stage, with result of −1 on the stack.

This instruction RMIN is conveyed by the following sequence:

M0: decodes the instruction;

M4: selects the operator MIN, compares R1 to R2, returns the lowest value to the ALU output, S<=(R1<R2)?R1: R2;

M7: selects the ALU output;

M1: selects the input corresponding to StackPointer+1 (result of −1 on the stack);

M2: is updated at the next clock stroke, if the enable input of the register is set to “1” (NextInstrAck=1);

M5: selects the input corresponding to StackPointer+2 (the data returned to R2 will be read);

M6: quiescent state;

M9: quiescent state;

M0: sets the inputs memory enable “Me” and write enable “We” of M3 to “1” and “0”, respectively, therefore, a read will be performed of the future value of R2;

M8: selects the StackManager output.

8. Instruction NEG

This instruction is used to return the two's complement negative value of the value contained in stage 0 of the stack. For example, if R1 contains 0x00000001, after execution of the instruction NEG, R1 will contain 0xFFFFFFFF.

This instruction NEG is conveyed by the following sequence:

M0: decodes the instruction;

M4: selects the operator NEG, S=not(x)+1(not(X) is the complement of X);

M7: selects the ALU output;

M1: selects the input corresponding to StackPointer (result of zero on the stack)

M2: is updated at the next clock stroke, if the enable input of the register is set to “1” (NextInstrAck=1);

M5: quiescent state;

M6: selects the StackPointer input;

M9: quiescent state;

M0: sets the inputs memory enable “Me” and write enable “We” of M3 to “0”;

M8: selects the input corresponding to R1.

9. Instruction SHL8ADD(x)

This instruction is used to perform a left shift of 8 bits of the content of the first stage and assign the value x to the 8 least significant bits of the content of the first stage, the result becoming the new content of the first stage, with a result of 0 on the stack.

This instruction SHL8ADD(x) is conveyed by the following sequence:

M0: decodes the instruction;

M4: let S be the ALU output, S=(R1<<8)|x;

M7: selects the ALU output;

M1: selects the input corresponding to StackPointer (result of 0 on the stack);

M2: is updated at the next clock stroke, if the enable input of the register is set to “1” (NextInstrAck=1);

M5: quiescent state;

M6: selects the StackPointer input;

M9: quiescent state;

M0: sets the inputs memory enable “Me” and write enable “We” of M3 to “0”;

M8: selects the input corresponding to R1.

10. Instruction FMULSH16 or FMULSH25

FMULSH25 and FMULSH16 are approximated multiplications of two 32-bit integers. FMULSH16 is used exclusively for MP3 decoding and FMULSH25 for WMA decoding. Given that, during arithmetic operations based on the multiplication, there will be a loss of precision due to the next arithmetic operations, the size of the multiplier is minimised such that the error due to simplifications is less than the final calculation precision. In this way, the size of the multiplier is minimised, hence a gain in the number of gates and a reduction in consumption.

This instruction FMULSH16 or FMULSH25 is conveyed by the following sequence:

M0: decodes the instruction;

M4: let S be the ALU output,

if RPLCON.0 =0;

then FMULSH16 (case of MP3);

S=(uint32)(((int32)(((R2>>11)+1)>>1))*((int32)(R1>>16)));

else FMULSH25 (case of WMA);

S=(int32)((((long long int)(((R1>>15)+1)>>1))*((long long int)(((R2>>6)+1)>>1)))>>9);

M7: selects the ALU output;

M1: selects the input corresponding to StackPointer+1 (result of −1 on the stack);

M2: is updated at the next clock stroke, if the enable input of the register is set to “1” (NextInstrAck=1);

M5: selects the input corresponding to StackPointer+2 (the data returned to R2 will be read);

M6: selects the StackPointer input;

M9: quiescent state;

M0: sets the inputs memory enable “Me” and write enable “We” of M3 to “1” and “0”, respectively;

M8: selects the StackManager output.

Appendix 2: Data Handling Instructions

The table below summarizes the various data handling instructions. The first column of the table identifies the name of the instruction, the second column specifies the argument (operand), the third one describes the arithmetic operation to be carried out and the last one indicates the result on the stack.

DATA HANDLING

| | | | |
|---|---|---|---|
| SWAP(x) | 8 bits | S0 <= 8x | 0 |
| | | 8X <= S0 | |
| DUP | none | duplicate S0 | 1 |
| DUPN(x) | 8 bits | duplicate Sx | 1 |
| DROP | none | drop S0 | −1 |
| PUSHD(x) | 8 bits | push x onto stack | 1 |
| SPLITW | none | S1 <= S0′HIGH | 1 |
| | | S0 <= S0′LOW | |
| MERGEW | none | S0 <= (S1 << 16) (S0 & 0xFFFF) | −1 |
| GETROM(x) | 8 bits | push rom value at | 1 |
| | | @(x + RplRomOffset) onto | |
| | | stack | |
| ROMOFFH(x) | 7 bits | RplRomOffset′HIGH <= x | 0 |
| ROMOFFL(x) | 8 bits | RplRomOffset′LOW <= x | 0 |

11. Instruction SWAP(x)

This instruction is used to invert the content of the first stage with that of the x^{th} stage, with a result of 0 on the stack.

This instruction RMAX is conveyed by the following sequence:

M0: decodes the instruction;

M4: quiescent state;

M7: if x>1, selects the StackManager output (a value is retrieved from the memory plane);

if x=0, selects R1;

if x=1, selects R2;

M1: selects the input corresponding to StackPointer (result of 0 on the stack);

M2: is updated at the next clock stroke, if the enable input of the register is set to “1” (NextInstrAck=1);

M5: selects the input corresponding to StackPointer+datareg as the read will be performed at the datareg position in the stack. This position is relative to StackPointer;

M6: selects the input corresponding to StackPointer+datareg as the write will be performed at the datareg position in the stack. This position is relative to StackPointer;

M9: selects the input corresponding to R1;

M0: sets the inputs memory enable “Me” and write enable “We” of M3 to “1”, therefore, a read will be performed at the address selected by M5 and a write at the address selected by M6;

M8: if x=1, selects the input R1, else R2.

12. Instruction DUP

This instruction is used to duplicate the content of the first stage in the first stage, with a result of +1 on the stack.

This instruction DUP is conveyed by the following sequence:

M0: decodes the instruction;

M4: no arithmetic operation, the ALU is not selected;

M7: selects R2;

M1: selects the input corresponding to StackPointer−1 (result of +1 on the stack);

M2: is updated at the next clock stroke, if the enable input of the register is set to “1” (NextInstrAck=1);

M5: quiescent state;

M6: selects the input StackPointer+1, the physical partition corresponding to R2 in the memory plane must be updated with the data of R2 which will be updated with the old value of R1;

M9: selects R2;

M0: sets the inputs memory enable “Me” and write enable “We” of M3 to “0” and “1”, respectively, a write will be performed to save the old value of R2 in the memory plane;

M8: selects the input R1.

13. Instruction DUPN(x)

This instruction is used to duplicate the content of the x^{th} stage in the first stage, with a result of +1 on the stack.

This instruction DUPN(x) is conveyed by the following sequence:

M0: decodes the instruction;

M4: no arithmetic operation, the ALU is not selected;

M7:

if x>1, selects the StackManager output (a value is retrieved from the memory plane);

if x=0, selects R1;

if x=1, selects R2;

M1: selects the input corresponding to StackPointer−1 (result of +1 on the stack);

M2: is updated at the next clock stroke, if the enable input of the register is set to “1” (NextInstrAck=1);

M5: selects the input corresponding to StackPointer+datareg as the read will be performed at the datareg position in the stack. This position is relative to StackPointer;

M6: selects the input StackPointer+1, the physical partition corresponding to R2 in the memory plane should be updated with the data of R2 which will be updated with the old value of R1;

M8: selects R1;

M0: sets the inputs memory enable “Me” and write enable “We” of M3 to “1”, therefore, a read will be performed at the address selected by M5 and a write at the address selected by M6;

M9: selects R2.

14. Instruction DROP

This instruction is used to delete the content of the first stage, with a result of −1 on the stack.

This instruction DROP is conveyed by the following sequence:

M0: decodes the instruction;

M4: no arithmetic operation, the ALU is not selected;

M7: selects R2;

M1: selects the input corresponding to StackPointer+1 (result of −1 on the stack);

M2: is updated at the next clock stroke, if the enable input of the register is set to “1” (NextInstrAck=1);

M5: selects the input corresponding to StackPointer+2 (the data returned to R2 will be read);

M6: quiescent state;

M9: quiescent state;

M0: sets the inputs memory enable “Me” and write enable “We” of M3 to “1” and “0”, respectively, therefore, the future value of R2 will be read;

M8: selects the StackManager input.

15. Instruction PUSHD(x)

This instruction is used to insert in the content of the first stage, the argument x of the instruction, with a result of +1 on the stack.

This instruction PUSHD(x) is conveyed by the following sequence:

M0: decodes the instruction;

M4: no arithmetic operation, the ALU is not selected;

M7: selects the input DataReg which corresponds to the argument part of the instruction;

M1: selects the input corresponding to StackPointer−1 (result of +1 on the stack);

M2: is updated at the next clock stroke, if the enable input of the register is set to “1” (NextInstrAck=1);

M5: quiescent state;

M6: selects the input StackPointer+1, the physical partition corresponding to R2 in the memory plane should be updated with the R2 output data;

M9: selects R2;

M0: sets the inputs memory enable “Me” and write enable “We” of M3 to “0” and “1”, respectively, a write will be performed at the address selected by M6;

M8: selects the input corresponding to R1.

16. Instruction SPLITW

This instruction is used to absorb the content of the first stage and return the 16 least significant bits in the content of the first stage and the 16 most significant bits in the content of the second stage, with a result of +1 on the stack.

This instruction SPLITW is conveyed by the following sequence:

M0: decodes the instruction;

M1: selects the input corresponding to StackPointer−1 (result of +1 on the stack);

M7: selects the input corresponding to “0000000000000000”&R1(15 downto 0);

M8: selects the input corresponding to “0000000000000000”&R1(31 downto 16);

M6: selects the input StackPointer+1;

M9: selects the input corresponding to R2.

17. Instruction MERGEW

This instruction is used to absorb the contents of the first and second stages and return in the content of the first stage a word wherein the 16 least significant bits are the 16 least significant bits of the content of the first stage, and the 16 most significant bits the 16 most significant bits of the content of the second stage, with a result of +1 on the stack.

This instruction MERGEW is conveyed by the following sequence:

M0: decodes the instruction;

M1: selects the input corresponding to StackPointer+1 (result of −1 on the stack);

M7: selects the input corresponding to &R2(15 downto 0)&R1(15 downto 0);

M8: quiescent state;

M5: selects the input StackPointer+2.

18. Instruction GETROM(x)

This instruction is used to insert in the content of the first stage the x^{th} element of a read only memory (ROM), with a result of +1 on the stack.

This instruction GETROM(x) is conveyed by the following sequence:

M0: decodes the instruction;

M4: no arithmetic operation, the ALU is not selected;

M7: selects the ROM output;

M1: selects the input corresponding to StackPointer−1 (result of +1 on the stack);

M2: is updated at the next clock stroke, if the enable input of the register is set to “1” (NextInstrAck=1);

M5: quiescent state;

M6: selects the input StackPointer+1, the physical partition corresponding to R2 in the memory plane should be updated with the R2 output data;

M9: selects R2;

M0: sets the inputs memory enable “Me” and write enable “We” of M3 to “0” and “1”, respectively, a write will be performed at the address selected by M6;

M8: selects the input corresponding to R1;

M26: determines the ROM address to access:

RomAdd=RomOffsetH&RomOffsetL+DataReg;

(DataReg'th element after that pointed to by the register base; RomOffsetH&RomOffsetL).

19. Instruction ROMOFFH(x)

This instruction is used to update with the value x the content of a register “RomOffH” storing the most significant bits of a reference value, with a result of 0 on the stack.

This instruction ROMOFFH(x) is conveyed by the following sequence:

M0: decodes the instruction;

M26: updates the register RomOffH on the basis of DataReg.

20. Instruction ROMOFFL(x)

This instruction is used to update with the value x the content of a register “RomOffL” storing the least significant bits of a reference value, with a result of 0 on the stack.

This instruction ROMOFFL(x) is conveyed by the following sequence:

M0: decodes the instruction;

M26: updates the register RomOffL on the basis of DataReg.

The disclosure provides a reverse Polish notation processing device that is simple to implement with hardware.

The disclosure also proposes such a processing device which, in at least one embodiment, is particularly well-suited to the execution of arithmetic operations.

The disclosure also proposes such a processing device which, in at least one embodiment, is particularly well-suited to the handling of data in a stack.

The disclosure also proposes such a processing device which, in at least one embodiment, is particularly well-suited to the decoding of audio streams.

The disclosure proposes such a processing device which, in one particular embodiment, is inexpensive, particularly in terms of resources.

The disclosure also proposes such a processing device which, in one particular embodiment, does not require any software overlay.

The disclosure further proposes such a processing device which, in one particular embodiment, is efficient, particularly in terms of electricity consumption.

Although the present disclosure has been described with reference to one or more embodiments, workers skilled in the art will recognize that changes may be made in form and detail without departing from the spirit and scope of the disclosure.

What is claimed is:

1. Reverse Polish notation processing device, allowing to execute a set of instructions wherein each instruction comprises N operands at most, where N≧1, said device implementing management of a stack whose size is variable, wherein the processing device comprises:
a storage device including a random access memory and a cache memory;
a stack pointer managing device, that manages a stack pointer, which is a physical address, in said random access memory, associated with a reference stage of the stack, each stage of the stack being associated with a physical address, in said random access memory, which varies according to the stack size; and
a contents managing device, which manages the contents of the stages of the stack, according to said stack pointer:
such that, for each of the first N stages of the stack, the content of said stage is stored in said cache memory, and for each of the other stages of the stack, the content of said stage is stored in said random access memory, at the physical address associated with said stage; and
allowing the content managing device to manage content overflows from the cache memory towards the random access memory, and vice-versa.

2. Device according to claim 1, wherein N is equal to 2.

3. Device according to claim 1, wherein the processing device is comprised in a coprocessor intended to cooperate with a main processor.

4. Device according to claim 1, wherein said reference stage of the stack is the first stage of the stack.

5. Device according to claim 1, wherein said stack pointer managing device includes:
a first multiplexer:
having three inputs receiving, respectively: the current value (StackPointer) of the stack pointer, said current value of the stack pointer incremented by one unit, and said current value of the stack pointer decremented by one unit;
delivering at its output one of the three input values, on the basis of a first control signal taking into account the result on the stack, +1, −1 or 0, of a current instruction;
a first register containing said current value of said stack pointer, the input of said first register being connected to the output of the first multiplexer, said first register being activated by an activation signal indicating that a next instruction is ready.

6. Device according to claim 1, wherein said contents managing device comprises a device for determining the next write address in said random access memory, comprising:
a second multiplexer:
having a plurality of inputs each receiving a current value of the stack pointer incremented or decremented by a distinctive determined value for each input; and
delivering at its output one of the input values, on the basis of a second control signal which is based on a current instruction.

7. Device according to claim 1, wherein said contents managing device comprises a device for determining the next read address in said random access memory, comprising:
a third multiplexer:
having a plurality of inputs each receiving a current value of the stack pointer incremented or decremented by a distinctive determined value for each input; and
delivering at its output one of the input values, on the basis of a third control signal which is based on a current instruction.

8. Device according to claim 6, wherein said plurality of inputs of the second multiplexer comprises at least two inputs belonging to the group comprising:
an input receiving said current value of the stack pointer incremented by a number of units indicated in an operand word of said current instruction;
an input receiving said current value of the stack point incremented by one unit;
an input receiving said current value of the stack point incremented by two units;
an input receiving said current value of the stack point decremented by one unit.

9. Device according to claim 1, wherein said contents managing device comprises a device for determining the next data to be written in said random access memory, comprising:
a fourth multiplexer:
having four inputs receiving, respectively: the current content of the first stage of the stack, the current content of the second stage of the stack, data read in the random access memory during execution of a current instruction, and data calculated during execution of a current instruction; and
delivering at its output one of the input values, on the basis of a fourth control signal which is based on a current instruction.

10. Device according to claim 1, wherein said contents managing device comprises a device for determining the next value to be written in said cache memory for the content of the first stage, comprising:
a fifth multiplexer:
having a plurality of inputs each receiving a distinctive determined value; and
delivering at its output one of the input values, on the basis of a fifth control signal which is based on a current instruction;
and wherein said cache memory comprises a second register containing a current value of the content of the first stage, the input of said second register being connected to the output of said fifth multiplexer, said second register being activated by an activation signal indicating that the next instruction is ready.

11. Device according to claim 10, wherein said plurality of inputs of the fifth multiplexer comprises at least two inputs belonging to the group comprising:
an input receiving the current value of the content of the first stage;
an input receiving the current value of the content of the second stage;
an input receiving a value indicated in an operand word of said current instruction;
an input receiving data read in the random access memory during the execution of a current instruction;
an input receiving data calculated during the execution of a current instruction.

12. Device according to claim 1, wherein said contents managing device comprises a device for determining the next value to be written in said cache memory for the content of the second stage, comprising:
a sixth multiplexer:
having a plurality of inputs each receiving a distinctive determined value; and
delivering at its output one of the input values, on the basis of a sixth control signal which is based on a current instruction;
and wherein said cache memory comprises a third register containing a current value of the content of the second stage, the input of said third register being connected to the output of said sixth multiplexer, said third register being activated by an activation signal indicating that the next instruction is ready.

13. Device according to claim 12, wherein said plurality of inputs of the sixth multiplexer comprises at least two inputs belonging to the group comprising:
an input receiving the current value of the content of the first stage;
an input receiving the current value of the content of the second stage;
an input receiving data read in the random access memory during the execution of a current instruction.

14. Device according to claims 1, wherein the processing device comprises an arithmetic calculation unit:
having two inputs receiving, respectively: a current value of the content of the first stage and a current value of the content of the second stage; and
delivering at its output data calculated with an arithmetic operator selected, from a plurality of operators, by a seventh control signal which is based on a current instruction.

15. Device according to claim 5, wherein each control signal is delivered by an instruction decoder which processes the current instruction contained in an instruction register.

16. Device according to claim 10, wherein the processing device also comprises a read only memory,
wherein said contents managing device comprises a device for determining the next read address in said read only memory, comprising:
an adder, allowing to add a value, indicated in the operand word of a current instruction, to a reference value, the output of said adder being connected to the read only memory and forming the next read address in said read only memory;
and wherein the output of the read only memory, on which the data item read is located, is connected to one of the inputs of the fifth multiplexer.

17. Device according to claim 16, wherein said device for determining the next read address in the read only memory comprise:
a fourth register containing least significant bits of said reference value;
a fifth register containing most significant bits of said reference value.

18. Device according to claim 1, wherein said set of instructions comprises at least one arithmetic instruction belonging to the group comprising:
an instruction used to absorb the contents of the first and second stages of the stack, the result becoming the new content of the first stage, with a result of −1 on the stack;
an instruction used to absorb the contents of the first and second stages, subtract the content of the second stage from the content of the first stage, the result becoming the new content of the first stage, with a result of −1 on the stack;
an instruction used to absorb the contents of the first and second stages and multiply them, the result becoming the new content of the first stage, with a result of −1 on the stack;
an instruction used to perform an unsigned shift to the left of one bit of the content of the first stage, the result becoming the new content of the first stage, with a result of 0 on the stack;
an instruction used to perform a signed shift to the right of one bit of the content of the first stage, the result becoming the new content of the first stage, with a result of 0 on the stack;
an instruction used to normalise two numbers present on the first two stages of the stack, the result on the stack being 0;
an instruction used to absorb the contents of the first and second stages and select the content with the highest value, the result becoming the new content of the first stage, with a result of −1 on the stack;
an instruction used to absorb the contents of the first and second stages and select the content with the lowest value, the result becoming the new content of the first stage, with a result of −1 on the stack;
an instruction used to return the two's complement negative value of the value contained in the first stage, this two's complement negative value becoming the new content of the first stage, with a result of 0 on the stack;
an instruction used to perform a shift to the left of 8 bits of the content of the first stage and assign the value x to the 8 least significant bits of the content of the first stage, the result becoming the new content of the first stage, with a result of 0 on the stack;
an instruction used to perform an approximate multiplication of two 32-bit integers, the result becoming the new content of the first stage, with a result of −1 on the stack.

19. Device according to claim 1, wherein said set of instructions comprises at least one data handling instruction belonging to the group comprising:
an instruction used to invert the content of the first stage of the stack with that of the x^{th} stage, with a result of 0 on the stack;
an instruction used to duplicate the content of the first stage in the first stage, with a result of +1 on the stack;
an instruction used to duplicate the content of the x^{th} stage in the first stage, with a result of +1 on the stack;
an instruction used to delete the content of the first stage, with a result of −1 on the stack;
an instruction used to insert in the content of the first stage the argument x of the instruction, with a result of +1 on the stack;
an instruction used to absorb the content of the first stage and return the 16 least significant bits in the content of the first stage and the 16 most significant bits in the content of the second stage, with a result of +1 on the stack;
an instruction used to absorb the contents of the first and second stages and return in the content of the first stage a word wherein the 16 least significant bits are the 16 least significant bits of the content of the first stage, and the 16 most significant bits the 16 least significant bits of the second stage, with a result of +1 on the stack;
an instruction used to insert in the content of the first stage the x^{th} element of a read only memory, with a result of +1 on the stack;
an instruction used to update with the value x the content of a register “RomOffH” storing most significant bits of a reference value, with a result of 0 on the stack;
an instruction used to update with the value x the content of a register “RomOffL”)) storing least significant bits of a reference value, with a result of 0 on the stack.

20. An electronic integrated circuit comprising a Reverse Polish notation processing device, allowing to execute a set of instructions wherein each instruction comprises N operands at most, where N≧1, said processing device implementing management of a stack whose size is variable, wherein the processing device comprises:
a storage device including a random access memory and a cache memory;
a stack pointer managing device, that manages a stack pointer, which is a physical address, in said random access memory, associated with a reference stage of the stack, each stage of the stack being associated with a physical address, in said random access memory, which varies according to the stack size; and
a contents managing device, which manages the contents of the stages of the stack, according to said stack pointer:
such that, for each of the first N stages of the stack, the content of said stage is stored in said cache memory, and for each of the other stages of the stack, the content of said stage is stored in said random access memory, at the physical address associated with said stage; and
allowing the content managing device to manage content overflows from the cache memory towards the random access memory, and vice-versa.
